(19) United States
(12) Patent Application Publication
(10) Pub. No.: US 2024/0378612 A1
(43) Pub. Date: Nov. 14, 2024

(54) TEMPO RADIX DLT BASED PAYMENT WATCH CUSTOMER AUTHENTICATION TECHNOLOGY

(71) Applicant: Bank of America Corporation, Charlotte, NC (US)

(72) Inventor: Saurabh Gupta, New Delhi (IN)

(21) Appl. No.: 18/144,972

(22) Filed: May 9, 2023

(51) Int. Cl. G06Q 20/40; G06Q 20/32

(52) U.S. Cl. CPC G06Q 20/4014; G06Q 20/321

(57) ABSTRACT

Methods for smartwatch-to-smartwatch payment authentication systems are provided. Methods include receiving a transfer of funds initiation at a first smartwatch. The transfer of funds initiation may include an identifier, an amount, and a Shard ID. Methods include transmitting the transfer of funds initiation from the first smartwatch to a second smartwatch. Methods may include receiving a notification on the second smartwatch. The notification may include a first smartwatch Shard ID and the transfer of funds initiation. Methods may include transmitting a transfer of funds request from the second smartwatch to an entity. The transfer of funds request may include the first smartwatch Shard ID, the transfer of funds initiation, and the second smartwatch Shard ID. Methods may include retrieving a first account and a second account from the entity. Methods may also include authenticating transactions between the first account and the second account. Tempo Radix logical counter may increase when Shard IDs from the first account and the second account are identical. Tempo Radix logical counter may be maintained when Shard IDs from the first account and the second account are different.

### FIELD OF TECHNOLOGY

Aspects of the disclosure relate to smartwatches. Specifically, this disclosure relates to smartwatch communications and authentications.

### BACKGROUND OF THE DISCLOSURE

Smartwatches have become more common in recent years. For the purposes of the disclosure, smartwatches may be understood to mean wearable watches that include one or more internal processors.

Smartwatches are compact devices and usually stay with the user. Therefore, smartwatches are easily accessible. Because of the ease of access associated with smartwatches, it would be desirable for a smartwatch to communicate with another smartwatch. It would be further desirable for a smartwatch to authenticate another smartwatch.

This patent application incorporates by reference in its entirety U.S. Pat. No. 11,308,474. U.S. Pat. No. 11,308,474 disclosed a technology that enabled payments between smartwatches by hovering the smartwatches next to each other. While this technology is valuable, it is risky to enable payments in this manner without proper authentication of the credibility of other smartwatch users.

It would be desirable to allow and enable a smartwatch user to proactively identify the authenticity of each customer immediately prior to a transaction. Such a technology would be beneficial to both smartwatch users and financial institutions by reducing fraud exponentially.

It would be further desirable for such authentication to obviate the need for authentication by associated mobile devices, desktop computers, laptop computers, card devices, or any other devices.

It would be yet further desirable for the authentication to include payment instructions and/or payment data.

It would be yet further desirable for the authentication between smartwatches to enable a first smartwatch to authenticate the transfer of funds from an account associated with the first smartwatch to an account associated with a second smartwatch.

### SUMMARY OF THE DISCLOSURE

Apparatus and methods for authentication of smartwatch-to-smartwatch transactions are provided. For the purposes of this application, smartwatches are wearable devices that are typically worn on a wrist. Smartwatches may include one or more processors. Smartwatches may execute various applications.

Exemplary smartwatch components may include standard watch components such as a strap, a casing, and a face.

Exemplary smartwatch components specific to a smartwatch may include a micro control unit (“MCU”), a central processing unit (“CPU”), a graphical processing unit (“GPU”), one or more faces including one or more screens, one or more sensors, a Bluetooth chipset, a haptic feedback unit, a global positioning system (“GPS”) receiver, a loudspeaker, a microphone, a printed circuit board (“PCB”), a power management unit, read only memory (“ROM”), random access memory (“RAM”), a touch screen controller, a waterproof seal, a universal serial bus (“USB”) controller, charging connectors, a radio receiver (Wi-Fi), a digital signal processor, a near-field communication (“NFC”) component, a micro-electro-mechanical system (“MEMS”) and a camera.

Exemplary MCUs may control sensors and processors included in the smartwatch.

Exemplary CPUs may execute the main processing on the smartwatch. Many smartwatch CPUs are licensed advanced reduced instruction set computing (RISC) machines (“arm”)® processors.

Exemplary GPUs may be processors that are used to reduce the workload on the CPU when rendering and generating the graphics on the smartwatch. The GPU may be a specialized circuit designed to rapidly manipulate and alter memory to accelerate the creation of images.

Exemplary smartwatch faces range from 30-60 mm long by 30-60 mm wide. Exemplary smartwatch screens may include a depth of approximately 5 mm to 20 mm. Exemplary smartwatch screens may have capacitive touch screens. Exemplary smartwatch screens can be made of various materials, such as traditional liquid crystal display (“LCD”), sharp memory LCD, in-plane switching (“IPS”) LCD with higher pixel density, electronic-ink (“E-ink”), organic light emitting diode (“OLED”), OLED with higher pixel density and interferometric modulator display technology (also referred to as mirasol display technology).

The display may be laminated onto polished sapphire crystal or other suitable substances. The sapphire crystal may be synthetic sapphire crystal. The display may be laminated onto ion x glass. It should be appreciated that ion x glass may be more flexible than sapphire crystal.

An exemplary universal serial bus (“USB”) controller is a controller that controls the input of a USB device and/or cable. In some instances, when a USB cable is used to charge the smartwatch, the connection between the USB controller and the USB cable may be a magnetic connection. The magnetic connection may appear to lack the typical USB port. This magnetic connection may avoid the space required when using a typical standard USB port, mini-USB port, or micro-USB port. This magnetic connection may also enable the waterproof compartment inside the smartwatch to maintain its waterproof capabilities.

Exemplary charging connectors may include the USB controller described above. Exemplary charging connectors may include any other suitable charging connectors.

An exemplary radio receiver may be a receiver capable of receiving radio waves. These radio waves may provide Wi-Fi and internet capabilities to the smartwatch.

An exemplary digital signal processor is a microprocessor chip with architecture augmented for the operational needs of digital signal processing.

An exemplary NFC component may provide NFC capabilities to the smartwatch. As such, the NFC component may enable the smartwatch to communicate with other smartwatches using NFC.

An exemplary MEMS may be a system that includes technology of microscopic devices. The system may include moving parts. In addition to micro-electro-mechanical components, system parts may also be rated on the nanoscale. As such, the system may include nano-electro-mechanical parts and nano-electro-mechanical technology. Because a relatively large amount of computation is performed within a relatively small region, various smartwatch components and processors may be made of and/or include MEMS components.

An exemplary smartwatch camera may capture photographs and/or videos.

One or more software modules may execute on the aforementioned processors. The one or more software modules may be stored in one or more memory locations located within the aforementioned memory included in the smartwatch. The one or more software modules may, in the alternative, be referred to as applications. The applications may enable the smartwatch to execute various tasks.

The method may include generating a transaction initiation at a first smartwatch. The transaction initiation may be the start of a transaction. Such a transaction may be a transfer of funds transaction or any other suitable transaction. In some embodiments, the first smartwatch may request a transfer of funds from an account associated with the first smartwatch to an account associated with a second smartwatch. In certain embodiments, the first smartwatch may request a transfer of funds from an account associated with the second smartwatch to an account associated with the first smartwatch.

In certain embodiments, the first smartwatch may request a transfer of funds from an account associated with the first smartwatch to a plurality of accounts associated with a plurality of counterparty smartwatches. As such, the first smartwatch may communicate with the plurality of smartwatches.

It should be appreciated that the first smartwatch may not have knowledge of an account number of the account associated with the second smartwatch. As such, the transaction initiation may trigger a transmission from the first smartwatch to the second smartwatch. The transmission may include a request for a second smartwatch telephone number.

The second smartwatch may respond to the transmission. The response may include the second smartwatch telephone number. The first smartwatch may transmit the second smartwatch telephone number to an entity. The entity may include a telephone number to account number resolver module. Such a telephone number to account number resolver module may identify an account number associated with a mobile telephone number. As such, the mobile telephone number to account number resolver module may identify an account number associated with the second smartwatch.

Once the account number associated with the second smartwatch is identified, the account number associated with the second smartwatch may be transmitted to the first smartwatch.

In some embodiments, the first smartwatch and/or the second smartwatch may maintain data in an internal storage location. When transactions between the first smartwatch and the second smartwatch have been executed, the first smartwatch and/or the second smartwatch may maintain data relating to the transaction in the internal storage location. The data may include the account number associated with the second smartwatch telephone number. As such, in the event the first smartwatch and the second smartwatch previously communicated, the first smartwatch may not communicate with the entity to determine the account number. Rather, the first smartwatch may locate the account number within the internal storage location.

Upon receipt and/or determination of the account number associated with the second smartwatch at the first smartwatch, the first smartwatch may request a transaction amount and a Shard ID from a user of the first smartwatch.

The transaction amount, Shard ID and/or any other suitable user input may be received at the first smartwatch, from the user, in a variety of ways. For example, the user input may be received from the user via touch gestures to one or more dynamic or static buttons on the first smartwatch.

The user input may also include any suitable combination of, or pattern of, tapping, squeezing, swiping and any other suitable touch-based input.

The user input may also be received from the user via tap gestures to one or more portions of the first smartwatch. Tap gestures may include receiving a series of taps. Each series of taps may correspond to a different value, such as a numerical value. Each series of taps may be separated from another series of taps with a delimiter.

The user input may also be received automatically from an internal or external processor.

Each smartwatch may be associated with one or more Shard IDs. A Shard ID is a unique ID assigned to a smartwatch. Each smartwatch has a memory for storing a previous subset of customer transactions in a particular chronological sequence. Each Shard ID is based at least in part on a previous subset of customer transactions in a particular chronological sequence.

A Shard ID may be obtained from a financial institution. A Shard ID may be at least in part based on a previous subset of customer transactions in a particular chronological sequence from the past, including, but not limited to, five, four, three, two, or one year(s).

Upon receipt of the transaction amount and the Shard ID at the first smartwatch, the first smartwatch may generate a transaction request. The transaction request may include an account number associated with a first smartwatch telephone number, an account number associated with a second smartwatch telephone number, a transaction amount, and a Shard ID.

The first smartwatch may transmit the transaction request to the entity. The entity may or may not be the same entity that is associated with a telephone number or account number. The entity may process the transaction request. The entity may transmit a transaction confirmation to the first smartwatch and/or the second smartwatch.

In some embodiments, the first smartwatch and/or the second smartwatch may authenticate the user before, during and/or after the transaction initiation and/or transaction generation. An authorization module, included in the first smartwatch and/or the second smartwatch, may authenticate the user of the smartwatch. The authentication may be executed at an authorization module included in the smartwatch. The authorization module may authenticate the user based on a group of detected user behavioral characteristics. The group of detected user behavioral characteristics may include gait, speed, voice detection, head movements and body movements. The authorization module may authenticate the user using any suitable authentication method. The authorization module may authenticate the user based on Shard ID validation.

In some embodiments, a Tempo Radix DLT-based smartwatch enabled for customer payment authentication is provided. A Tempo Radix DLT smartwatch may determine the authenticity and credibility of all other smartwatch users, immediately prior to making payment, spontaneously, and over the authenticating smartwatch display itself.

In some embodiments, a Tempo Radix DLT-based smartwatch uses the Tempo Radix mechanism of a distributed ledger technology (“DLT”). The Tempo Radix mechanism of a distributed ledger technology stores transactions chronologically based on time stamps. The Tempo Radix DLT may be used with blockchain technology.

In some embodiments, smartwatches establish communication with other smartwatches located within a threshold distance. This communication enables smartwatches to share Shard IDs—both their own and interacting smartwatch customers.

In some embodiments, the authenticating smartwatch utilizes a Shard ID represented by a previous subset of customer transactions. The previous subset of customer transactions could be, for example, details concerning the customer's past 10 transactions.

In some embodiments, the authenticating smartwatch, smartwatch A, shares the Shard ID of smartwatch B, the smartwatch being authenticated, with a financial institution. The financial institution then confirms whether the shared Shard ID and sequence in the Shard ID are valid and matches smartwatch B's Shard ID.

In some embodiments, failure to confirm Shard ID validity will result in an unapproved identity and transaction rejection.

In some embodiments, the same mechanism will be repeated by the other smartwatch in the transaction, smartwatch B, to determine the authenticity of the other smartwatch, smartwatch A.

In some embodiments, a Tempo Radix DLT-based smartwatch will enable the smartwatches to implement an increase in the logical counter of transactions present in Tempo Radix, over each smartwatch. If the Shard IDs are validated, the logical counter will increase. If the Shard IDs are not validated, the logical counter will be maintained.

In some embodiments, upon successful Shard ID validation, the logical counter on each smartwatch increases by at least one point and is displayed on each smartwatch display.

In some embodiments, a logical counter increase indicates that the information provided against the Shard ID is valid, and the current transaction is approved and added to Tempo Radix.

In some embodiments, all failed and successful transactions will be recorded over Tempo Radix and each smartwatch's financial institution for future reference.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows an illustrative flow diagram in accordance with principles of the disclosure;

FIG. 3 shows yet another illustrative diagram in accordance with principles of the disclosure;

FIG. 4 shows still another illustrative diagram in accordance with principles of the disclosure; and

FIG. 5 shows still yet another illustrative diagram in accordance with principles of the disclosure.

FIG. 6 shows another illustrative flow diagram in accordance with principles of the disclosure;

### DETAILED DESCRIPTION OF THE DISCLOSURE

Apparatus and methods for authentication of smartwatch-to-smartwatch payment systems is provided.

A smartwatch may include a plurality of hardware components and software components, such as those described in detail in the summary of the disclosure. The hardware components may include a watch face and a band. The watch face may rest on a user's wrist. The band may wrap around the user's wrist and secure the watch face relative to the user's wrist.

The hardware components may also include one or more microprocessors. At least one of the microprocessors may be operable to initiate a transaction.

The hardware components may also include one or more displays. At least one of the displays may display software displays. The microprocessor may instruct the display regarding the software displays.

The hardware components may also include a battery. The battery may power the display and/or the microprocessor.

The hardware components may also include a nano wireless network interface card (“NIC”). The nano wireless NIC may establish communication with a wireless network.

The hardware components may also include an active NFC reader. The active NFC reader may detect one or more other smartwatches within a predetermined proximity to the smartwatch. The active NFC reader may establish communication with the one or more other smartwatches.

The smartwatch may also include a plurality of software components.

The plurality of software components may include a digital number pad. The digital number pad may display numerical digital software selections to the user. The digital number pad may also receive numerical input from the user. In some embodiments, the digital number pad may not operate as a typical digital number pad. For example, the digital number pad may accept tap gesture input and/or musical patterns that correspond to one or more numerals.

The plurality of software components may also include an information controller module. The information controller module may capture data via the digital number pad. The captured data may include a transaction amount and/or a Shard ID. As such, the received numerical input may correspond to the transaction amount and/or the Shard ID.

The plurality of software components may also include an NFC controller module. The NFC controller module may operate as the software for the active NFC reader. As such, the NFC controller module may activate NFC communication via the NFC reader.

The NFC controller module may also send and/or receive user data, payment data and/or authentication data. As such, the NFC controller module may receive the captured data from the information controller module. The captured data may include the transaction amount and/or the Shard ID. The NFC controller module may transmit the captured data to a wireless controller module.

The NFC controller module may communicate with the one or more other smartwatches. As such, the NFC controller module may communicate with a second smartwatch. The second smartwatch may be one of the one or more other smartwatches. The communication from the smartwatch to the second smartwatch may include a request for a second smartwatch mobile telephone number.

The NFC controller module may receive the second smartwatch mobile telephone number from the second smartwatch.

The plurality of software components may also include the wireless controller module. The wireless controller module may interface between the nano wireless NIC and an external Wi-Fi device. The external Wi-Fi device may be included in the wireless network. The Wi-Fi device may be within sufficient proximity to the smartwatch to communicate with the software and hardware components included in the Wi-Fi device.

The wireless controller module may also transmit the captured data to an external entity. The transmission of the captured data may be communicated over the wireless network.

The NFC controller module and/or the wireless controller module may include multiple modes. The modes may include discoverable mode and non-discoverable mode. In a discoverable mode, the smartwatch may be actively searching for other devices. In a non-discoverable mode, the smartwatch may not be actively searching for devices.

The plurality of software components may also include an amount and Shard validation module. The amount and Shard validation module may verify the transaction amount and/or the Shard ID with the external entity.

As stated above, the microprocessor, included in the smartwatch, may initiate a transaction. The microprocessor may generate a transaction request. The transaction request may be a transfer of funds instruction. A benefactor account of the transaction request may be the account associated with the telephone number of the initiating smartwatch. A beneficiary account of the transaction request may be the account associated with the second smartwatch mobile telephone number.

The transaction request may include an account number associated with the initiating smartwatch. The transaction request may include the transaction amount. The transaction request may include the Shard ID. The transaction request may include the smartwatch account number associated with the second smartwatch mobile telephone number.

The microprocessor may transmit the generated transaction request to the entity. The entity may process the transaction request.

Upon completion of processing the transaction request at the entity, the entity may transmit a confirmation to the initiating smartwatch and/or to the second smartwatch. The confirmation(s) may notify regarding the completion of the transaction request processing.

The confirmation(s) may also include details relating to the transaction. Such details may include one or more account numbers and/or a portion of one or more account numbers. Such details may also include a transaction amount. Such details may also include a date-time stamp.

At times, a smartwatch may be unable to connect to a wireless network, such as the internet. As such, one or more smartwatches involved in a transaction may communicate with one another using NFC, Bluetooth® or another suitable technology. The transaction may be completed offline—i.e., without communicating with a wireless network. The transaction data may be stored within smartwatches. The transaction data may include the following: user information (may be the benefactor and/or beneficiary), transaction amount, counterparty user information (may be the benefactor and/or beneficiary), authentication information, location information, past payment information, past purchase information and any other suitable information. The transaction data may be stored in a blockchain using an immutable cryptographic signature which cannot be altered. When one or both smartwatches are reconnected to a network, the transactions can be picked from the blockchain and forwarded for processing at one or more financial institutions.

In some embodiments, to facilitate smartwatch to smartwatch transactions, currency may be stored on the smartwatch. For example, digital currency can be stored in currency form on the smartwatch for offline, or online, transactions.

Provided herein are methods for authentication of smartwatch-to-smartwatch transactions utilizing Tempo Radix DLT.

In some embodiments, a method for authentication of smartwatch-to-smartwatch transactions involves generating a transaction initiation at a first smartwatch.

In some embodiments, a method for authentication of smartwatch-to-smartwatch transactions involves triggering, by the transaction initiation, a transmission, from a first smartwatch to a first processor. A first processor forms a part of a first processing entity. The transmission is a request for a second smartwatch Shard ID associated with a second smartwatch.

In some embodiments, a method for authentication of smartwatch-to-smartwatch transactions involves a Shard ID. A Shard ID is a unique ID assigned to a smartwatch, which has a memory for storing a previous subset of customer transactions in a particular chronological sequence.

In some embodiments, a given smartwatch's Shard ID is based at least in part on a previous subset of customer transactions in a particular chronological sequence.

In some embodiments, a method for authentication of smartwatch-to-smartwatch transactions involves transmitting, from a first processor to a first smartwatch, a second smartwatch Shard ID.

In some embodiments, a method for authentication of smartwatch-to-smartwatch transactions involves receiving, at a first smartwatch, a second smartwatch Shard ID.

In some embodiments, a method for authentication of smartwatch-to-smartwatch transactions involves triggering, by a request for a second smartwatch Shard ID, a transmission from a second smartwatch to a second processor. A second processor forms a part of a second processing entity. The transmission is a request for a first smartwatch Shard ID associated with the first smartwatch.

In some embodiments, a method for authentication of smartwatch-to-smartwatch transactions involves transmitting, from a second processing entity to a second smartwatch, a first smartwatch Shard ID.

In some embodiments, a method for authentication of smartwatch-to-smartwatch transactions involves receiving, at a second smartwatch, a first smartwatch Shard ID.

In some embodiments, a method for authentication of smartwatch-to-smartwatch transactions involves generating a transaction request at a first smartwatch involving a first smartwatch Shard ID associated with a first smartwatch.

In some embodiments, a method for authentication of smartwatch-to-smartwatch transactions involves a second smartwatch Shard ID associated with a second smartwatch.

In some embodiments, a method for authentication of smartwatch-to-smartwatch transactions involves transmitting a transaction request to a first processor.

In some embodiments, a method for authentication of smartwatch-to-smartwatch transactions involves processing a transaction request at the first processor based on a first smartwatch Shard ID and a second smartwatch Shard ID.

In some embodiments, a method for authentication of smartwatch-to-smartwatch transactions involves receiving, at a first smartwatch and at a second smartwatch, approval from a first processor.

In some embodiments, a method for authentication of smartwatch-to-smartwatch transactions involves generating a transaction request at a second smartwatch. The transaction request involves a first smartwatch Shard ID associated with a first smartwatch.

In some embodiments, a method for authentication of smartwatch-to-smartwatch transactions involves a second smartwatch Shard ID associated with the second smartwatch.

In some embodiments, a method for authentication of smartwatch-to-smartwatch transactions involves transmitting a transaction request to a second processor.

In some embodiments, a method for authentication of smartwatch-to-smartwatch transactions involves processing a transaction request at a second processor based on a first smartwatch Shard ID and a second smartwatch Shard ID.

In some embodiments, a method for authentication of smartwatch-to-smartwatch transactions involves receiving, at a first smartwatch and at a second smartwatch, approval from a second processor.

In some embodiments, a method for authentication of smartwatch-to-smartwatch transactions involves comparing a first smartwatch Shard ID and a second smartwatch Shard ID, and, when a first smartwatch Shard ID and a second smartwatch Shard ID are determined, based on a comparison, to be identical, increasing, at a first smartwatch and at a second smartwatch, a logical counter in Tempo Radix, and, when a first smartwatch Shard ID and a second smartwatch Shard ID are determined, based on a comparison, to be different, then maintaining a logical counter in Tempo Radix at a current level.

In some embodiments, a method for authentication of smartwatch-to-smartwatch transactions involves displaying, at a first smartwatch and at a second smartwatch, a status of a transaction.

In some embodiments, a method for authentication of smartwatch-to-smartwatch transactions involves validating one or more Shard ID, by a first smartwatch and at a second smartwatch, using an artificial intelligence-based past transaction validator by comparing a previous subsets of customer transactions in chronological sequences to a legacy transaction lookup table.

In some embodiments, a method for authentication of smartwatch-to-smartwatch transactions involves processing, by a first processor and a second processor, by using a fraud detection controller. A fraud detection controller determines fraud statuses and controls the first and second processors' transactions based on fraud statuses.

In some embodiments, a method for authentication of smartwatch-to-smartwatch transactions involves recording, by a first and second processor, any transaction denial and approval over Tempo Radix.

In some embodiments, a method for authentication of smartwatch-to-smartwatch transactions involves a transaction, including, but not limited to, a transfer of funds transaction.

In some embodiments, a method for authentication of smartwatch-to-smartwatch transactions involves a beneficiary of a transfer of funds transaction, including, but not limited to, a beneficiary of a transfer of funds transaction for an account associated with a second smartwatch Shard ID.

In some embodiments, a method for authentication of smartwatch-to-smartwatch transactions involves a beneficiary of a transfer of funds transaction, including, but not limited to, a beneficiary of a transfer of funds transaction for an account associated with a first smartwatch Shard ID.

In some embodiments, a Tempo Radix DLT smartwatch has a plurality of hardware components.

In some embodiments, a Tempo Radix DLT smartwatch has a microprocessor operable to initiate a transaction.

In some embodiments, a Tempo Radix DLT smartwatch has a display operable to display software displays as instructed by a microprocessor.

In some embodiments, a Tempo Radix DLT smartwatch has a battery operable to power the display and a microprocessor.

In some embodiments, a Tempo Radix DLT smartwatch has a nano wireless network interface card for establishing communication with a wireless network.

In some embodiments, a Tempo Radix DLT smartwatch has an active near field communication (“NFC”) reader operable to detect one or more other smartwatches within a predetermined proximity to the smartwatch and establish communication with the one or more other smartwatches.

In some embodiments, a Tempo Radix DLT smartwatch has a plurality of software components, including, but not limited to an information controller module operable to capture a Shard ID.

In some embodiments, a Tempo Radix DLT smartwatch has an NFC controller module operable to activate NFC communication via an NFC reader; receive, from an information controller module a transaction amount and a Shard ID; transmit, to a wireless controller module a transaction amount and a Shard ID; a wireless controller module, a wireless controller module operable to interface between a nano wireless network interface card and an external Wi-Fi device included in a wireless network; and transmit, over a wireless network, a transaction amount and a Shard ID to an external entity; and Shard validation module operable to verify a Shard ID with an external entity; and capable of generating a transaction initiation at a first smartwatch.

In some embodiments, a Tempo Radix DLT smartwatch involves triggering, by a transaction initiation, a transmission, from a first smartwatch to a first processor, forming a part of a first processing entity, a request for a second smartwatch Shard ID associated with a second smartwatch.

In some embodiments, a Tempo Radix DLT smartwatch is associated with one or more Shard IDs.

In some embodiments, a Tempo Radix DLT smartwatch involves transmitting, from a first processor to a first smartwatch, a second smartwatch Shard ID.

In some embodiments, a Tempo Radix DLT smartwatch involves receiving, at the a smartwatch, a second smartwatch Shard ID.

In some embodiments, a Tempo Radix DLT smartwatch involves triggering, by a request for a second smartwatch Shard ID, a transmission, from a second smartwatch to a second processor forming a part of a second processing entity. The transmission is a request for a first smartwatch Shard ID associated with a first smartwatch.

In some embodiments, a Tempo Radix DLT smartwatch involves transmitting, from a second processing entity to a second smartwatch, a first smartwatch Shard ID.

In some embodiments, a Tempo Radix DLT smartwatch involves receiving, at a second smartwatch, a first smartwatch Shard ID.

In some embodiments, a Tempo Radix DLT smartwatch involves generating a transaction request at a first smartwatch.

In some embodiments, a Tempo Radix DLT smartwatch involves a first smartwatch Shard ID associated with a first smartwatch.

In some embodiments, a Tempo Radix DLT smartwatch involves a second smartwatch Shard ID associated with a second smartwatch.

In some embodiments, a Tempo Radix DLT smartwatch involves transmitting the transaction request to a first processor.

In some embodiments, a Tempo Radix DLT smartwatch involves processing a transaction request at a first processor based on a first smartwatch Shard ID and a second smartwatch Shard ID.

In some embodiments, a Tempo Radix DLT smartwatch involves receiving, at the first smartwatch and at the second smartwatch, approval from the first processor.

In some embodiments, a Tempo Radix DLT smartwatch involves generating a transaction request at a second smartwatch, involving a first smartwatch Shard ID associated with a first smartwatch; the second smartwatch Shard ID; said second smartwatch Shard ID associated with the second smartwatch.

In some embodiments, a Tempo Radix DLT smartwatch involves transmitting a transaction request to a second processor.

In some embodiments, a Tempo Radix DLT smartwatch involves processing a transaction request at a second processor based on a first smartwatch Shard ID and a second smartwatch Shard ID.

In some embodiments, a Tempo Radix DLT smartwatch involves receiving, at a first smartwatch and at a second smartwatch, approval from a second processor.

In some embodiments, a Tempo Radix DLT smartwatch involves comparing a first smartwatch Shard ID and a second smartwatch Shard ID, and, when a first smartwatch Shard ID and a second smartwatch Shard ID are determined, based on a comparison, to be identical, increasing, at a first smartwatch and at a second smartwatch, a logical counter in Tempo Radix, and, when a first smartwatch Shard ID and a second smartwatch Shard ID are determined, based on a comparison, to be different, then maintaining a logical counter in Tempo Radix at a current level.

In some embodiments, a Tempo Radix DLT smartwatch involves displaying, at the first smartwatch and at the second smartwatch, a status of the transaction.

In some embodiments, a Tempo Radix DLT smartwatch involves a wireless controller module operable to validate a Shard ID using an artificial intelligence-based past transaction validator by comparing previous subsets of customer transactions in chronological sequences to a legacy transaction lookup table.

In some embodiments, a Tempo Radix DLT smartwatch involves a fraud detection controller, which determines fraud statuses and controls transactions based on fraud statuses.

In some embodiments, a Tempo Radix DLT smartwatch involves a recording module operable to record any transaction denial and approval over Tempo Radix.

In some embodiments, a Tempo Radix DLT smartwatch involves a transaction, including, but not limited to, a transfer of funds transaction.

In some embodiments, a Tempo Radix DLT smartwatch involves a beneficiary of the transfer of funds transaction, wherein the beneficiary of the transfer of funds transaction is the account associated with a second smartwatch Shard ID.

In some embodiments, a Tempo Radix DLT smartwatch involves a beneficiary of the transfer of funds transaction, wherein the beneficiary of the transfer of funds transaction is the account associated with a first smartwatch Shard ID.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

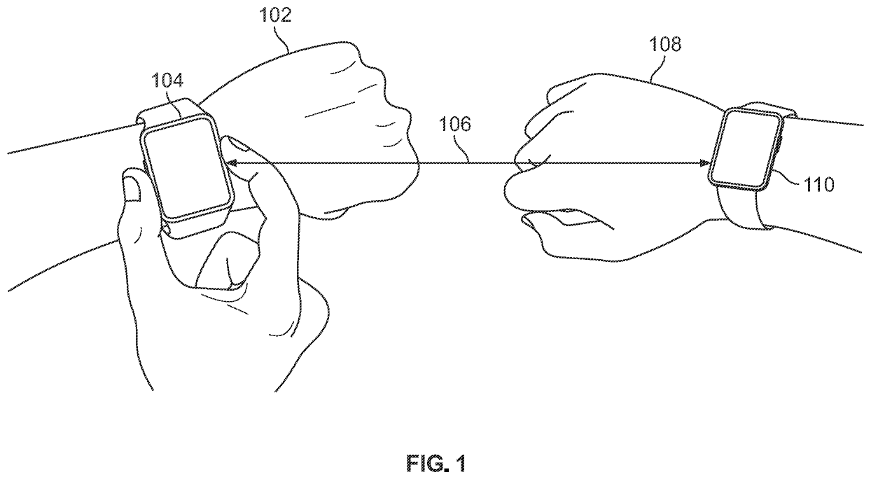

FIG. 1 shows an illustrative diagram. The illustrative diagram shows smartwatch-to-smartwatch communication. Smartwatch 104 may be worn by user 102. Smartwatch 110 may be worn by user 108. Smartwatches 104 and 110 may include capabilities such as those described above. Smartwatch 104 and smartwatch 110 may communicate with each other, as shown at communication 106. The communication may be an NFC-based communication. The communication may be a Wi-Fi-based communication. The communication may utilize any other suitable technology.

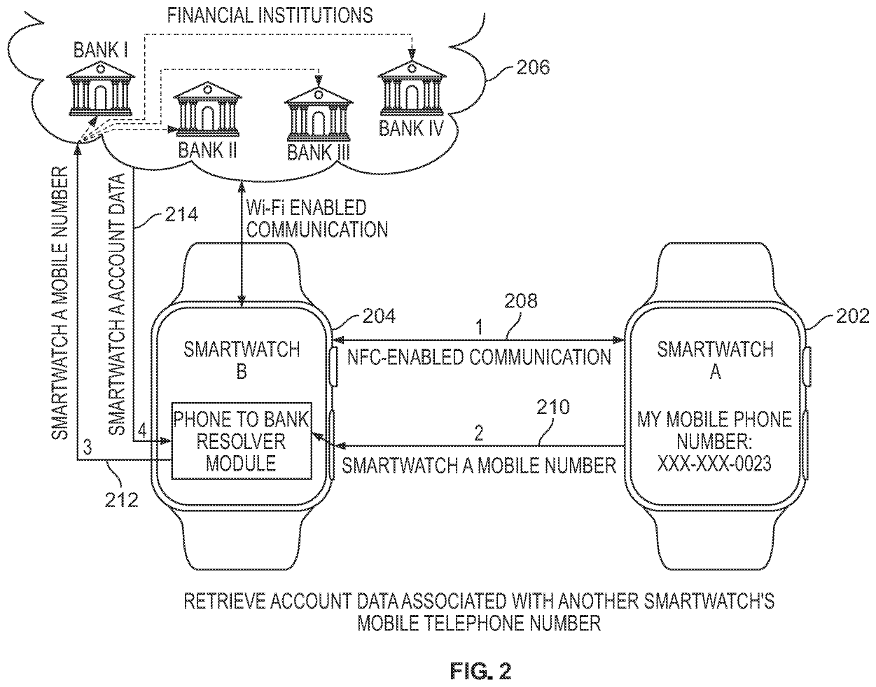

FIG. 2 shows an illustrative diagram. The illustrative diagram shows communication between a first smartwatch (smartwatch A), shown at 202, a second smartwatch (smartwatch B), shown at 204 and a plurality of financial institutions, shown at 206. The communications included in FIG. 2 show retrieving account data associated with another smartwatch's mobile telephone number.

It should be appreciated that the communications between smartwatch A and smartwatch B may be NFC-enabled or Bluetooth®-enabled communications. It should be further appreciated that the communications between smartwatch B and financial institutions 206 may be Wi-Fi®-enabled communications.

Smartwatch A may be associated with mobile telephone number XXX-XXX-0023. Smartwatch B may be associated with mobile telephone number XXX-XXX-6789 (not shown).
Step 1 of an exemplary communication is shown at 208. Step 1 may include initiation of a communication. The communication may be an NFC-enabled communication. The communication may be a payment communication. The payment communication may be transmitted from smartwatch A to smartwatch B and/or from smartwatch B to smartwatch A. In some embodiments, the initial communication between smartwatch A and smartwatch B may be a handshake communication.

The communication may include a transfer of funds instruction. The intent of the transfer of funds instruction may be to transfer funds from an account associated with smartwatch A to an account associated with smartwatch B. Each account may be linked to its respective smartwatch via the associated mobile telephone number. The payment communication that is transferred from smartwatch A to smartwatch B may include the mobile telephone number associated with smartwatch A.
Step 2 of the exemplary communication is shown at 210. In response to receiving the payment communication, smartwatch A may transmit its associated mobile telephone number to smartwatch B. The smartwatch A mobile telephone number may be received at the phone to bank resolver module within smartwatch B.
Step 3 of the exemplary communication is shown at 212. The phone to bank resolver module may communicate with each financial institution included in plurality of financial institutions 206. The communication may include attempting to identify account data associated with the smartwatch A mobile phone number. The phone to bank resolver may transmit the smartwatch A mobile phone number to each financial institution included in plurality of financial institutions 206. The response from each financial institution 206 may include either account data or a null response.

Financial institutions that do not have account data associated with the transmitted phone number may transmit null responses. In some embodiments, null responses may not be transmitted to smartwatch B. Rather, only responses with account data may be transmitted to the phone to bank resolver module.
Step 4 of the exemplary communication is shown at 214. The response, including the account data, may be received at the phone to bank resolver module. The phone to bank resolver module may link the received account data to the mobile phone number associated with smartwatch A.

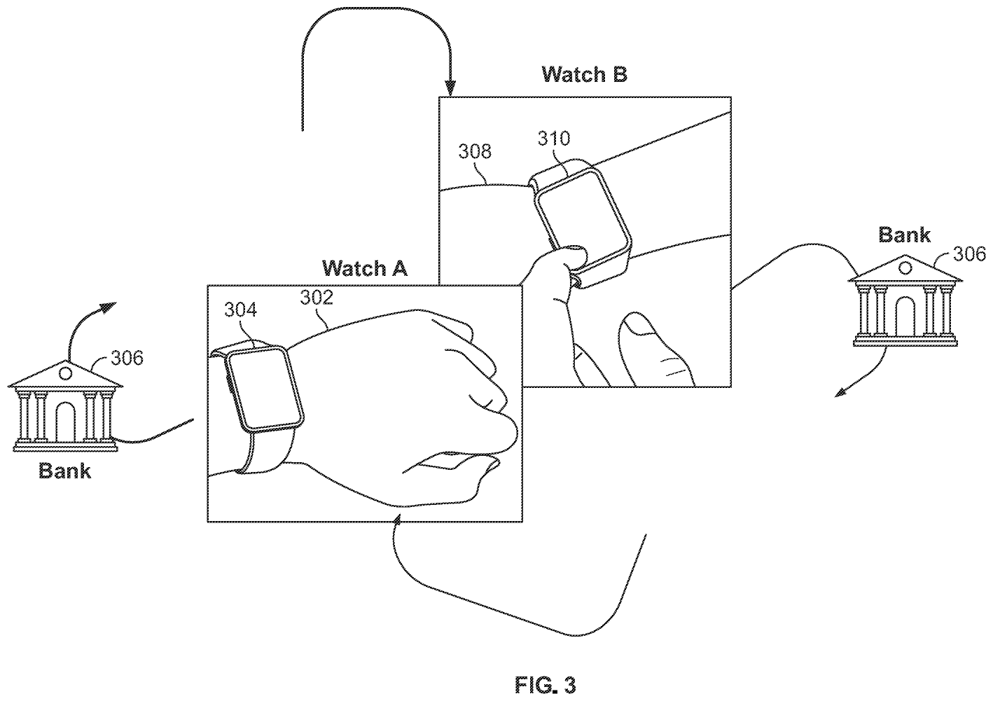

FIG. 3 shows an illustrative diagram. The illustrative diagram shows a completion of a transaction between smartwatch A, shown at 304, worn on hand 302, and smartwatch B, shown at 310, worn on hand 308, and financial institutions, shown at 306. It should be appreciated that the steps (1-10) shown in FIG. 3 commence after smartwatch A 304 begins communication with smartwatch B 310.
Step 1 shows smartwatch A 304 initiating communication with smartwatch B 310.
Step 2 shows that smartwatch B 310 may prompt, via NFC communication, smartwatch A 304 to request a Shard ID.
Step 3 shows smartwatch A 304 request a Shard ID from its own financial institution 306.
Step 4 shows smartwatch A 304 receiving a Shard ID entry from its own financial institution 306.
Step 5 shows smartwatch A 304 transmitting its own Shard ID to smartwatch B 310.
Step 6 shows smartwatch B 310 initiating communication with smartwatch A 304.
Step 7 shows that smartwatch A 304 may prompt, via NFC communication, smartwatch B 310 to request a Shard ID.
Step 8 shows smartwatch B 310 request a Shard ID from its own financial institution 306.
Step 9 shows smartwatch B 310 receiving a Shard ID entry from its own financial institution 306.
Step 10 shows smartwatch B 310 transmitting its own Shard ID to smartwatch A 304.

It should be appreciated that although FIG. 3 shows smartwatch A 304 as the benefactor and smartwatch B 310 as the beneficiary, in other embodiments, the payment instruction may include smartwatch A 304 as the beneficiary and smartwatch B 310 as the benefactor.

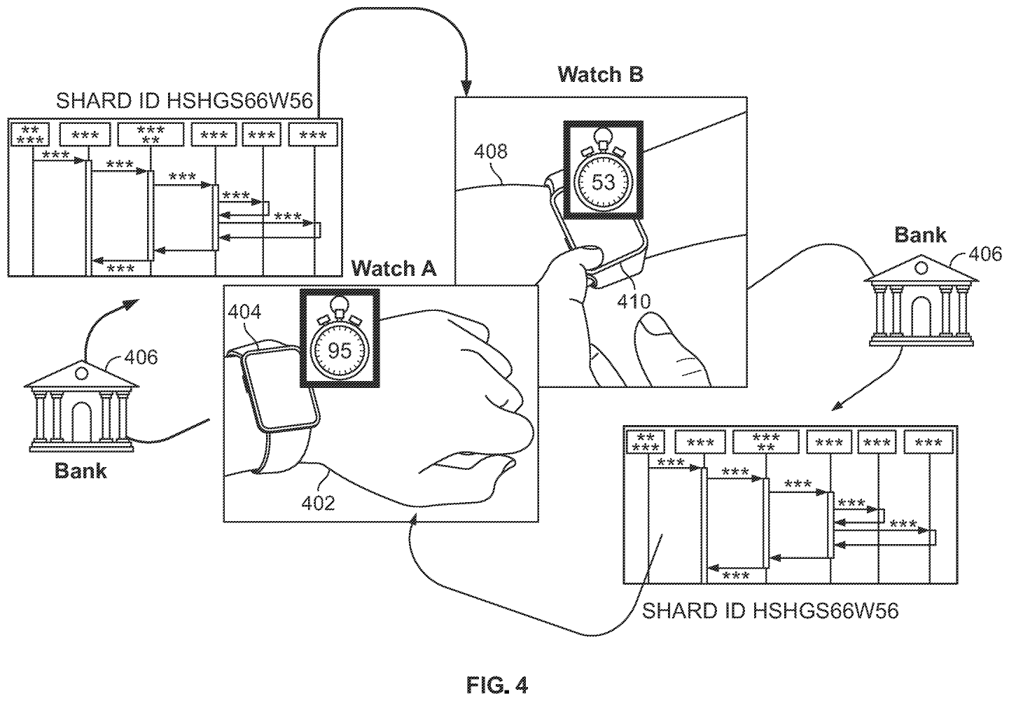

FIG. 4 shows an exemplary diagram for a payment authentication system where funds can be transferred from an account associated with a first smartwatch 404, worn on hand 402, to an account associated with a second smartwatch 410, worn on hand 408.

Smartwatch 404 initiates a transaction with smartwatch 410. Smartwatch 404′s financial institution 406 generates a Shard ID “HSHGS66W56” based on a previous subset of transactions. This Shard ID is sent to smartwatch 410.

Smartwatch 410 communicates with its own financial institution 406. Its own financial institution 406 generates its own Shard ID for smartwatch 410. This Shard ID is “HSHGS66W56.”

The two Shard IDs “HSHGS66W56” and “HSHGS66W56” are identical. Therefore, the transaction is allowed to proceed. The valid transaction is represented by “95” over smartwatch 404 and “53” over smartwatch 410 indicating Tempo Radix logical counter increasing in both.

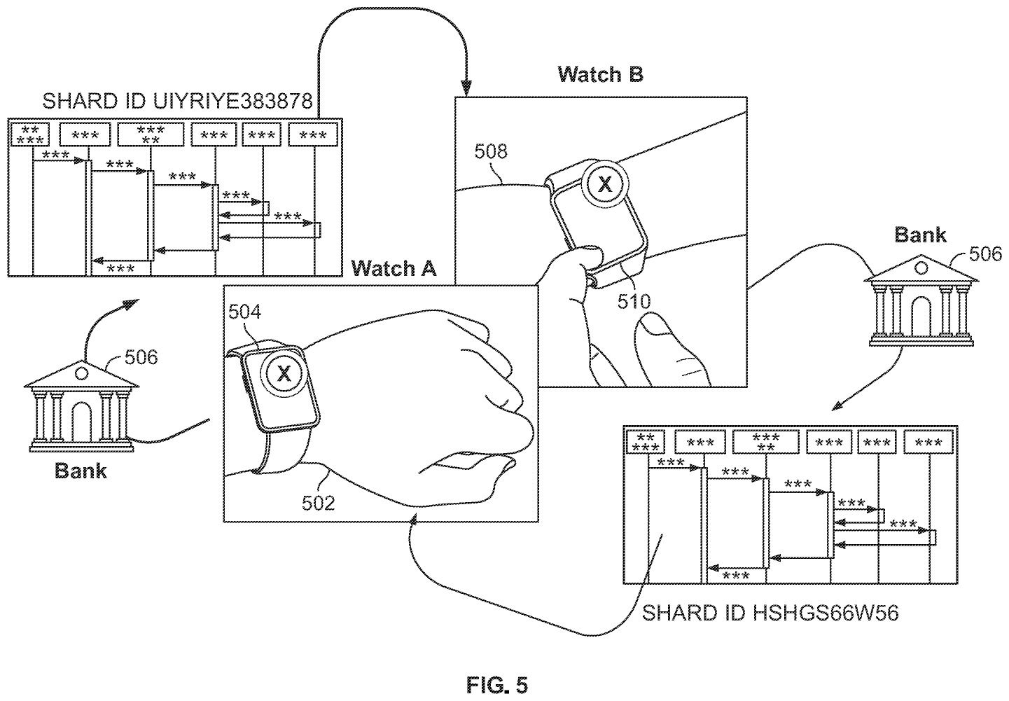

FIG. 5 shows an exemplary diagram for a payment authentication system where funds can be transferred from an account associated with a first smartwatch 504, worn on hand 502, to an account associated with a second smartwatch 510, worn on hand 508.

Smartwatch 504 initiates a transaction with smartwatch 510. Smartwatch 504's financial institution 506 generates a Shard ID “UIYRIYE383878” based on a previous subset of transactions. This Shard ID is sent to smartwatch 510.

Smartwatch 510 communicates with its own financial institution 506. Its own financial institution 506 generates its own Shard ID for smartwatch 510. This Shard ID is “HSHGS66W56.” This Shard ID is sent to smartwatch 504.

The two Shard IDs “UIYRIYE383878” and “HSHGS66W56” are not identical. Therefore, the transaction is not allowed to proceed. The invalid transaction is represented by “X” over each smartwatch.

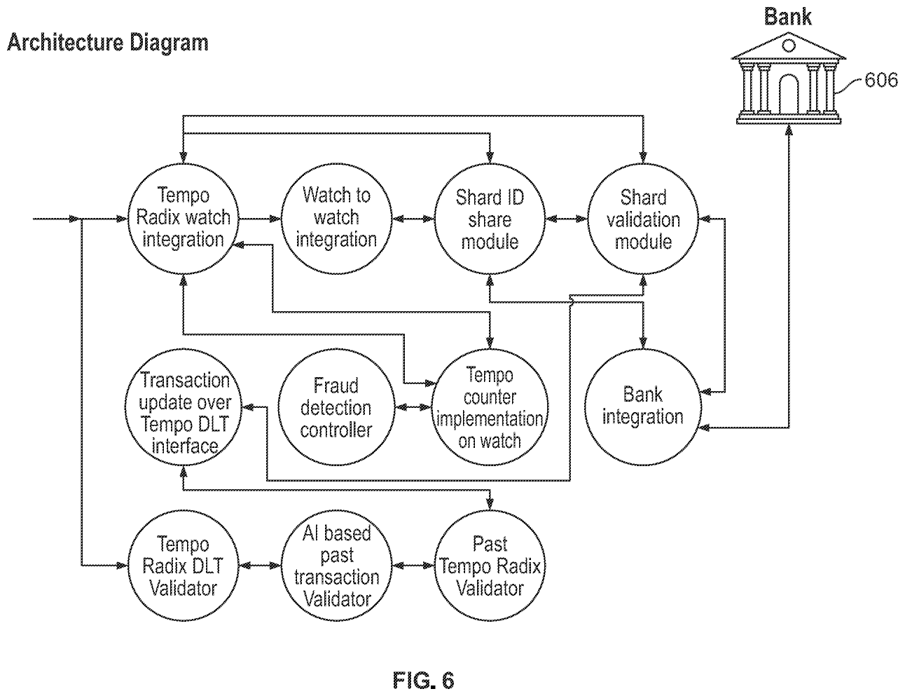

FIG. 6 shows an exemplary illustrative flowchart. A first smartwatch initiates a transaction with a second smartwatch, which triggers Tempo Radix watch integration.

Tempo Radix watch integration module is responsible for smartwatch integration with a Tempo Radix distributed ledger transaction repository. The Tempo Radix distributed ledger transaction repository may be held with a financial institution 606.

Tempo Radix watch integration module is responsible for integration of the smartwatch with the transaction batch and the distributed ledger maintained on Tempo Radix.

Watch to watch integration module is responsible for a first smartwatch establishing communication with a second smartwatch.

Shard ID share module is responsible for obtaining a valid Shard ID from a financial institution 606 and sharing the valid Shard ID with another smartwatch.

Shard validation module is responsible for validation of Shard IDs. The Shard validation module performs verification of the actual sequence of transactions shared by the second smartwatch.

Bank to bank integration module is responsible for a smartwatch's integration with its own financial institution 606. Bank to bank integration can also enable communication with another smartwatch's financial institution 606 to obtain Shard IDs.

Tempo counter implementation module is responsible for increasing or decreasing a Tempo Radix logical counter based on Shard ID validation. Shard ID validation is based on a comparison of the Shard IDs produced by both smartwatches.

Fraud detection controller module is responsible for identifying fraud. Fraud detection controller module may detect whether other smartwatches have been involved in fraud in the past or in the present transaction.

Transaction update over Tempo DLT interface module is responsible for carrying the transaction further and updating the transaction over Tempo DLT interface.

Past Tempo Radix Validator module is responsible for smartwatch validating its own past transactions.

AI based past transaction validator module is responsible for smartwatch validation of past transactions that another smartwatch produced.

Tempo Radix DLT validator module is responsible for enabling a smartwatch to check a previously shared batch of transactions and validating the authenticity of the previously shared batch of transactions.

The Past Tempo Radix Validator module and the Tempo Radix DLT validator module may be combined into one module.

Thus, smartwatch-to-smartwatch payment authentication systems are provided. Persons skilled in the art will appreciate that the present invention can be practiced by other than the described embodiments, which are presented for purposes of illustration rather than of limitation. The present invention is limited only by the claims that follow.

What is claimed is:

1. A method for authentication of smartwatch-to-smartwatch transactions, the method comprising:
generating a transaction initiation at a first smartwatch;
triggering, by the transaction initiation, transmission, from the first smartwatch to a first processor, said first processor forming a part of a first processing entity, a request for a second smartwatch Shard ID, said second smartwatch Shard ID associated with the second smartwatch;
wherein a Shard ID is a unique ID, said unique ID assigned to a smartwatch, said smartwatch comprising a memory, said memory for storing a previous subset of customer transactions in a particular chronological sequence, said Shard ID being based at least in part on the previous subset of customer transactions in said particular chronological sequence;
transmitting, from the first processor to the first smartwatch, the second smartwatch Shard ID;
receiving, at the first smartwatch, the second smartwatch Shard ID;
triggering, by the request for a second smartwatch Shard ID, transmission, from the second smartwatch to a second processor, said second processor forming a part of a second processing entity, a request for a first smartwatch Shard ID, said first smartwatch Shard ID associated with the first smartwatch;
transmitting, from the second processing entity to the second smartwatch, the first smartwatch Shard ID;
receiving, at the second smartwatch, the first smartwatch Shard ID;
generating a transaction request at the first smartwatch, said transaction request comprising:
a first smartwatch Shard ID, said first smartwatch Shard ID associated with the first smartwatch;
the second smartwatch Shard ID; said second smartwatch Shard ID associated with the second smartwatch;
transmitting the transaction request to the first processor;
processing the transaction request at the first processor based on the first smartwatch Shard ID and the second smartwatch Shard ID; and
receiving, at the first smartwatch and at the second smartwatch, approval from the first processor;
generating a transaction request at the second smartwatch, said transaction request comprising:
a first smartwatch Shard ID, said first smartwatch Shard ID associated with the first smartwatch;
the second smartwatch Shard ID; said second smartwatch Shard ID associated with the second smartwatch;
transmitting the transaction request to a second processor;
processing the transaction request at the second processor based on the first smartwatch Shard ID and the second smartwatch Shard ID; and
receiving, at the first smartwatch and at the second smartwatch, approval from the second processor;
comparing the first smartwatch Shard ID and the second smartwatch Shard ID, and, when the first smartwatch Shard ID and the second smartwatch Shard ID are determined, based on the comparison, to be identical, increasing, at the first smartwatch and at the second smartwatch, the logical counter in Tempo Radix, and, when the first smartwatch Shard ID and the second smartwatch Shard ID are determined, based on the comparison, to be different, then maintaining the logical counter in Tempo Radix at a current level; and
displaying, at the first smartwatch and at the second smartwatch, a status of the transaction.

2. The method of claim 1, comprising:
validating the Shard IDs, by the first smartwatch and at the second smartwatch, using an artificial intelligence-based past transaction validator by comparing the previous subsets of customer transactions in chronological sequences to a legacy transaction lookup table.

3. The method of claim 1, comprising:
processing, by the first and second processors, using a fraud detection controller, wherein the fraud detection controller determines fraud statuses and controls the first and second processors' transaction based on the fraud statuses.

4. The method of claim 1, comprising:
recording, by the first and second processors, any transaction denial and approval over Tempo Radix.

5. The method of claim 1, wherein the transaction is a transfer of funds transaction.

6. The method of claim 5, wherein:
a beneficiary of the transfer of funds transaction is the account associated with the second smartwatch Shard ID; and
a benefactor of the transfer of funds transaction is the account associated with the first smartwatch Shard ID.

7. A Tempo Radix DLT smartwatch comprising:
a plurality of hardware components comprising:
a microprocessor, said microprocessor operable to initiate a transaction;
a display, said display operable to display software displays as instructed by the microprocessor;
a battery, said battery operable to power the display and the microprocessor;
a nano wireless network interface card, said nano wireless network interface card for establishing communication with a wireless network;
an active near field communication (“NFC”) reader, said active NFC reader operable to:
detect one or more other smartwatches within a predetermined proximity to the smartwatch; and
establish communication with the one or more other smartwatches;
a plurality of software components comprising:
an information controller module, said information controller module operable to capture:
a Shard ID, wherein a Shard ID is a unique ID, said unique ID assigned to a smartwatch, said smartwatch comprising a memory, said memory for storing a previous subset of customer transactions in a particular chronological sequence, said Shard ID being based at least in part on the previous subset of customer transactions in said particular chronological sequence;
an NFC controller module, said NFC controller module operable to:
activate NFC communication via the NFC reader;
receive, from the information controller module:
the transaction amount; and
the Shard ID;
transmits, to a wireless controller module:
the transaction amount; and
the Shard ID;
the wireless controller module, said wireless controller module operable to:
interface between the nano wireless network interface card and an external Wi-Fi device, said external Wi-Fi device included in the wireless network; and
transmit, over the wireless network, the transaction amount and the Shard ID to an external entity;
an amount and Shard validation module, said amount and Shard validation module operable to verify the Shard ID with the external entity; and
capable of generating a transaction initiation at a first smartwatch;
triggering, by the transaction initiation, transmission, from the first smartwatch to a first processor, said first processor forming a part of a first processing entity, a request for a second smartwatch Shard ID, said second smartwatch Shard ID associated with the second smartwatch;
wherein a Shard ID is a unique ID, said unique ID assigned to a smartwatch, said smartwatch comprising a memory, said memory for storing a previous subset of customer transactions in a particular chronological sequence, said Shard ID being based at least in part on the previous subset of customer transactions in said particular chronological sequence;
transmitting, from the first processor to the first smartwatch, the second smartwatch Shard ID;
receiving, at the first smartwatch, the second smartwatch Shard ID;
triggering, by the request for a second smartwatch Shard ID, transmission, from the second smartwatch to a second processor, said second processor forming a part of a second processing entity, a request for a first smartwatch Shard ID, said first smartwatch Shard ID associated with the first smartwatch;
transmitting, from the second processing entity to the second smartwatch, the first smartwatch Shard ID;
receiving, at the second smartwatch, the first smartwatch Shard ID;
generating a transaction request at the first smartwatch, said transaction request comprising:
a first smartwatch Shard ID, said first smartwatch Shard ID associated with the first smartwatch;
the second smartwatch Shard ID; said second smartwatch Shard ID associated with the second smartwatch;
transmitting the transaction request to the first processor;
processing the transaction request at the first processor based on the first smartwatch Shard ID and the second smartwatch Shard ID; and
receiving, at the first smartwatch and at the second smartwatch, approval from the first processor;
generating a transaction request at the second smartwatch, said transaction request comprising:
a first smartwatch Shard ID, said first smartwatch Shard ID associated with the first smartwatch;
the second smartwatch Shard ID; said second smartwatch Shard ID associated with the second smartwatch;
transmitting the transaction request to a second processor;
processing the transaction request at the second processor based on the first smartwatch Shard ID and the second smartwatch Shard ID; and
receiving, at the first smartwatch and at the second smartwatch, approval from the second processor;
comparing the first smartwatch Shard ID and the second smartwatch Shard ID, and, when the first smartwatch Shard ID and the second smartwatch Shard ID are determined, based on the comparison, to be identical, increasing, at the first smartwatch and at the second smartwatch, the logical counter in Tempo Radix, and, when the first smartwatch Shard ID and the second smartwatch Shard ID are determined, based on the comparison, to be different, then maintaining the logical counter in Tempo Radix at a current level; and
displaying, at the first smartwatch and at the second smartwatch, a status of the transaction.

8. The Tempo Radix DLT smartwatch of claim 7, comprising the wireless controller module operable to:
validate a Shard ID using an artificial intelligence-based past transaction validator by comparing previous subsets of customer transactions in chronological sequences to a legacy transaction lookup table.

9. The Tempo Radix DLT smartwatch of claim 7, comprising:
a fraud detection controller, wherein the fraud detection controller determines fraud statuses and controls transactions based on the fraud statuses.

10. The Tempo Radix DLT smartwatch of claim 7, comprising:
a recording module operable to record any transaction denial and approval over Tempo Radix.

11. The Tempo Radix DLT smartwatch of claim 7, wherein the transaction is a transfer of funds transaction.

12. The Tempo Radix DLT smartwatch of claim 11, wherein:
a beneficiary of the transfer of funds transaction is the account associated with the second smartwatch Shard ID; and
a benefactor of the transfer of funds transaction is the account associated with the first smartwatch Shard ID.
